(19) United States
(12) Patent Application Publication
(10) Pub. No.: US 2010/0070243 A1
(43) Pub. Date: Mar. 18, 2010

(54) Wire Harness Unfolding

(76) Inventors: Jean-Marc Yvon, Cheshire (GB); Steven Trythall, Gwynedd (GB); Andrew Cooper, Cheshire (GB)

Correspondence Address: MENTOR GRAPHICS CORP.;PATENT GROUP, 8005 SW BOECKMAN ROAD, WILSONVILLE, OR, 97070-7777, US

(21) Appl. No.: 12/501,344

(22) Filed: Jul. 10, 2009

Related U.S. Application Data
(60) Provisional application No. 61/079,791, filed on Jul. 10, 2008.

(51) Int. Cl. G06F 17/50

(52) U.S. Cl. 703/1

(57) ABSTRACT

Various implementations of the invention provide methods and apparatus for determining an unfolded connector clocking angle corresponding to a folded wire harness. More particularly, various implementations of the invention may be employed to manipulate or “unfold” a three-dimensional wire harness representation into a two-dimensional representation such that the two-dimensional connector clocking angle may be determined. In various implementations of the invention, the wire harness is approximated as an alternating series of straight segments and curved segments. Subsequently, the curved segments are straightened or “unfolded” such that the wire harness may be contained within a single geometric plane. As the curved segments are unfolded, the positioning of the wire harness connectors and the connector clocking angles is transformed. As a result, the connector clocking angles for an unfolded wire harness may be determined.

### RELATED APPLICATIONS

The present application claims priority under 35 U.S.C. §119 to U.S. Provisional Patent Application No. 61/079,791, entitled “Wiring Harness Unfolding,” filed on Jul. 10, 2009 and naming Steven Trythall et al. as inventors, which application is incorporated entirely herein by reference.

### FIELD OF THE INVENTION

The invention relates to the field of electronic design automation. Particularly, various implementations of the invention relate to the design of wire and wiring harnesses, and more particularly, to unfolding a three dimensional representation of a wire harness.

### BACKGROUND OF THE INVENTION

Modern vehicles, including automobiles, aircraft, watercraft, and spacecraft have electrical systems. These electrical systems are interconnected by numerous electrical conductors, which provide for communication, interoperability, and power delivery between the different components in the electrical systems. In a typical vehicle, these different components are often located throughout the vehicle. Accordingly, the electrical conductors must be routed throughout the vehicle in order to connect the different components. Often, sets of electrical conductors are bundled together to facilitate routing the conductors throughout the vehicle. These bundles of electrical conductors are typically referred to as a wiring harness or wiring assembly. A single bundle of electrical conductors within a wiring harness may have multiple “branches” or “take-outs” that branch off from the bundle. As a result, the entire wiring harness may have a tree like structure, enabling the interconnection of multiple locations within the vehicle.

Wiring harnesses designed for modern vehicles and electrical systems are quite complicated. Accordingly, designing these wiring harnesses is often a very difficult undertaking. For example, even a reasonably simple automobile has dozens of interconnected electrical subsystems, each of which may involve dozens of wires interconnecting sensors at various points in the engine, engine compartment, chassis, fuel tank, cabin, and exhaust system. These sensors are additionally interconnected with numerous monitoring and control modules. The wiring harness must include enough individual connectors for the various components, as well as individual wires with sufficient length between connections. Additionally, the wires must have the performance capability to communicate signals, handle sufficient loads, and satisfy other environmental and performance constraints.

In the case of larger and more complex systems, such as an aircraft, the concerns are greater. Today's aircraft tend to replace mechanical and hydraulic systems with electrical systems, resulting in more complex wiring systems. At the same time, additional electrical systems are used in contemporary aircraft which further multiply the number and complexity of their wiring. The size of the wiring harness increases as the number of electrical conductors needed in a given design increases. The thickness of any given branch in a modern wiring harness, due to the required number of electrical conductors, typically makes the branches of the wiring harness quite rigid and inflexible once they are manufactured. In addition, the space for routing a wiring harness through a vehicle, such as for example through the frame or chassis, is often limited.

The connectors of the wiring harness are often “keyed” to a particular electrical component for which they are designed to connect. For example, an electrical connector may have a notch at a particular angular location on the connector and the component connector may have a corresponding protrusion shaped like the notch at the same angular location. Herein, the particular description of the method used to key an electrical connector is often referred to as the connector clocking angle. Keying the electrical connectors helps prevent the inadvertent connecting of an electrical connector to the wrong component, and assures correct electrical polarity and suitable alignment of the wiring harness. As a result, of the rigidity of the wiring harness, the limited space in which the harness is often routed, and the keyed nature of the connectors, the connectors must typically be situated in a particular position to properly connect with the component connectors.

Manufacturing wiring harnesses in the vehicle chassis or even in a finished three-dimensional form as needed to be installed in the vehicle is difficult if not impossible given the complexity and design constraints of modern vehicle wiring harnesses. Accordingly, wiring harnesses are typically constructed on a single geometric plane, in two-dimensional form, and “folded” or manipulated from the two-dimensional form into the three dimensional form needed during or prior to installation. As the wiring harness is folded from a two-dimensional configuration to a three-dimensional configuration, the positioning of the electrical connectors move and twist. As a result, the position of the electrical connectors in three-dimensional space is different than the position of the electrical connectors in two-dimensional space. Accordingly, the initial position of the electrical connectors, i.e. the positioning in which the electrical connectors are manufactured, must be such that the final or folded position provides for proper alignments between the electrical connectors and the component connectors as needed for proper installation.

As stated above, wiring harnesses are typically designed in three-dimensional form via various computer aided design tools. However, the manufacture of the three-dimensional design in two-dimensions may cause the connector clocking angles to be manufactured as incorrect angles. Prior art methods for designing and manufacturing a wire harness have not properly accounted for the required translation between a three-dimensional design and the corresponding two-dimensional design.

### SUMMARY OF THE INVENTION

Various implementations of the invention provide methods and apparatus for determining an unfolded connector clocking angle corresponding to a folded wire harness. More particularly, various implementations of the invention may be employed to manipulate or “unfold” a three-dimensional wire harness representation into a two-dimensional representation such that the two-dimensional connector clocking angle may be determined. In various implementations of the invention, the wire harness is approximated as an alternating series of straight segments and curved segments. Subsequently, the curved segments are straightened or “unfolded” such that the wire harness may be contained within a single geometric plane. As the curved segments are unfolded, the positioning of the wire harness connectors and the connector clocking angles are transformed to correspond with the unfolding of the wire harness representation. As a result, the connector clocking angles for an unfolded wire harness representation may be determined.

These and additional aspects, features and implementations of the invention will be further understood from the following detailed disclosure of illustrative embodiments.

### BRIEF DESCRIPTION OF THE DRAWINGS

The present invention will be described by way of illustrative embodiments shown in the accompanying drawings in which like references denote similar elements, and in which:

FIG. 1 illustrates an electrical connector;

FIG. 2 illustrates a wiring harness in two-dimensional form;

FIG. 3 illustrates the wiring harness of FIG. 2, in three-dimensional form;

FIG. 4 illustrates a computer system, useable for implementing various embodiments of the present invention;

FIG. 5 illustrates a computer processing unit of the computer system illustrated in FIG. 4;

FIG. 6 illustrates a method of determining unfolded connector clocking angles for a wiring harness design;

FIG. 7 illustrates a method of unfolding a wiring harness design;

FIG. 8 illustrates a wire harness;

FIG. 8A illustrates the wire harness of FIG. 8, partially unfolded;

FIG. 8B illustrates the wire harness of FIG. 8, fully unfolded;

FIG. 9 illustrates a method of straightening a segment of a wire harness branch;

FIG. 10 illustrates a wire harness branch;

FIG. 11 illustrates a wire harness branch;

FIG. 11A illustrates the wire harness branch of FIG. 11, partially unfolded;

FIG. 11B illustrates the wire harness branch of FIG. 11, fully unfolded;

FIG. 12 illustrates a method of unfolding a wire harness design;

FIG. 13 illustrates a wire harness design model;

FIG. 14 illustrates a method of identifying a main bundle and a main take out;

FIG. 15 illustrates a method of deriving an unfolding plane;

FIG. 16 illustrates a wire harness design;

FIG. 17 shows the wire harness design of FIG. 16, in an alternate view;

FIG. 18 illustrates a method of unfolding a wire harness branch representation;

FIG. 19 illustrates a wire harness design;

FIG. 20 illustrates the wire harness design of FIG. 19;

FIG. 21 illustrates a method processing a dogleg;

FIG. 22 illustrates a dogleg.

### DETAILED DESCRIPTION OF ILLUSTRATIVE EMBODIMENTS

### Introduction

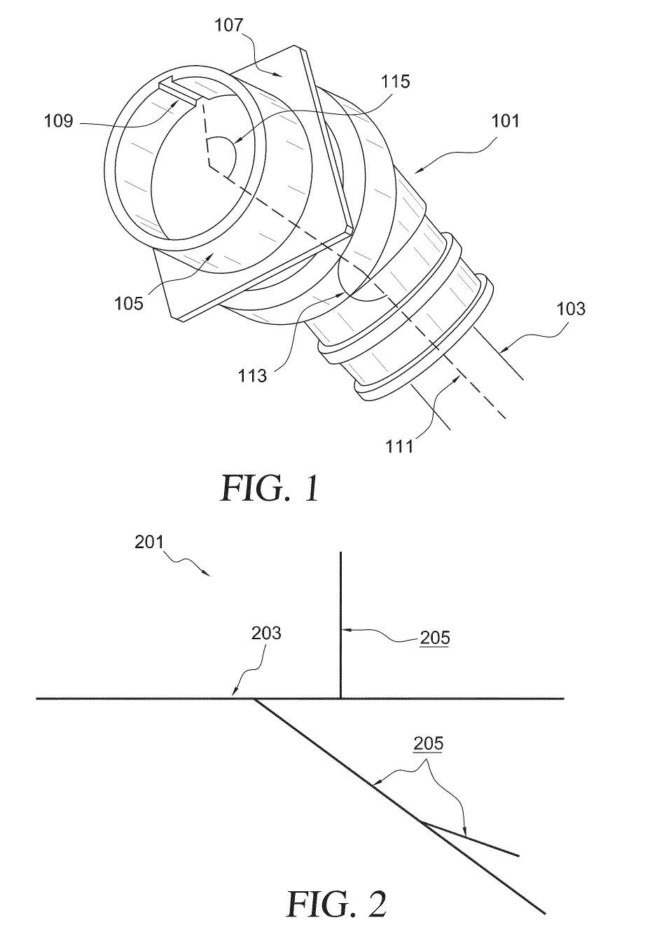

As indicated above, wiring harnesses include electrical connectors that facilitate connection between various components within an electrical system, such as the electrical system of an airplane. Additionally as indicated, electrical connectors are often keyed to ensure that particular components are interconnected as well as to ensure proper alignment and polarity of the connection. For example, FIG. 1 illustrates an electrical connector 101 terminally connected to a wiring harness branch 103. As can be seen from this figure, the electrical connector 101 has a connection flange 105 and a connection backshell 107. Additionally as can be seen from this figure, the connection flange 105 is keyed with a notch 109. The position of the notch 109 and the connector backshell 107 may be measured relative to a given axis. For example, the axis 111 of the electrical connection 101 and the harness branch 103 is shown. Accordingly, an angular rotation 113 between the axis 111 and the connector backshell 107 and the angular rotation 115 between the axis 111 and the notch 109 may be determined. The angular rotation 113 and 115 (i.e. the angular location or position of the notch 109 and the connector backshell 107) are often referred to as the connector clocking angle.

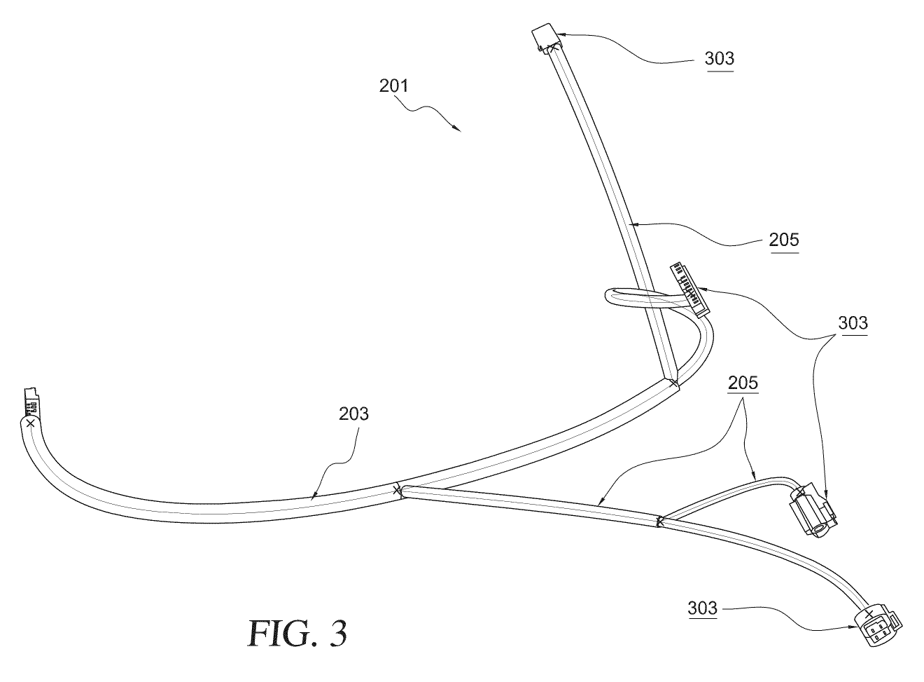

As further stated above, wiring harnesses are often constructed in two-dimensional form. More particularly, wiring harnesses are often constructed in a single geometric plane. For example, FIG. 2 illustrates a wiring harness design 201, including a main harness branch 203, and takeout branches 205. As can be seen from this figure, the wiring harness design 201 is illustrated in a single geometric plane, i.e. the wiring harness is substantially flat. As additionally stated above, wiring harnesses are designed and installed in three-dimensional form. Accordingly, once a wiring harness is manufactured it is folded or manipulated into the three-dimensional form called for in the design and needed for installation. For example, FIG. 3 illustrates a wiring harness design 201′, which is the wiring harness 201 of FIG. 2 in three-dimensional form. As can be seen from this figure, the main branch 203′ and the take out branches 205′ have a plurality of bends and curves that give the wiring harness 201′ a three-dimensional shape.

FIG. 3 additionally illustrates electrical connectors 303 that are terminally connected to the branches of the wiring harness 201′. As can be seen from this figure, the electrical connectors 303 each have a distinct position in three-dimensional space. As used herein, “wiring harness” may refer to a physical wiring harness, or the design for, or representation of a physical wiring harness. A wiring harness design may be embodied on a computer readable medium, may be graphically represented on a computer display device, such as for example a liquid crystal display panel, or may be printed on a physical printing medium such as draft paper. When used herein, a “folded wiring harness” refers to a wiring harness arranged in three-dimensional form while an “unfolded wiring harness” refers to a wiring harness arranged in two-dimensional form.

As indicated above, since wiring harnesses are often manufactured unfolded, the electrical connectors of the wiring harness must start, i.e., be manufactured, at a particular position in order for the electrical connectors to have the required position when the harness is folded. For example, the electrical connectors 303 have a particular folded position as illustrated in FIG. 3. These same electrical connectors would have a different, but corresponding position if the wiring harness 203′ were unfolded into the two-dimensional form as shown in FIG. 2.

Various implementations of the invention may use wire harness design information. For presentation purposes, the present disclosure sometimes refers to wire harness components by their physical counterparts, such as electrical connectors, conductors, and other such terms. It should be understood, however, that any such reference not only includes the physical components but also representations of such circuit components and signals on the components as may be used in a computer implemented electronic design automation (EDA) tool.

Various implementations of the invention may be employed to unfold a wiring harness design. For example, the wiring harnesses designed for an automobile, an airplane, a marine vehicle, or other electrical system needing interconnectivity. Furthermore, various embodiments of the invention may be implemented to manipulate, modify, or otherwise change data representing a wiring harness design. However, as those of skill in the art will appreciate, the manipulated, modified, or otherwise changed data represents the wiring harness design for a physical wiring harness. Accordingly, the wiring harness design may be employed in a manufacturing process to create the physical wiring harness according to the manipulated, modified, or otherwise changed wiring harness design. With various implementations, the intermediate results or the final output produced by any of the disclosed methods, apparatus, and systems can be stored on one or more computer readable medium as part of the described methods and techniques. Additionally, a computer readable medium bearing the intermediate results or the final output may be accessed and used by a single programmable computing device or a plurality of programmable computing devices, such as, for example, a computing workstation connected on a network to a computing server.

Any of the methods or techniques described herein can be performed using software that comprises computer executable instructions for causing a computer to perform the methods or techniques stored on one or more computer readable medium. Such software can comprise, for example, an electronic design automation tool. With various implementations of the invention, the software may be executed on a single computer. With other implementations, the software may be executed upon a networked computer system. For example, via the Internet, a wide area network, a local area network, a client server network, or other such network. For clarity, some details that are well known in the art are omitted. For example, it should be understood that the disclosed technology is not limited to any specific computer language or program. An illustrative computing environment is described, but it is to be understood that this environment is not limiting and although all possible computing environments are not described, those of skill in the art are still capable of practicing the invention based upon the following disclosure.

### Illustrative Computing Environment

Although the operations of some of the disclosed methods, apparatus, and systems are described in a particular, sequential order for convenient presentation, it should be understood that this manner of description encompasses rearrangement, unless a particular ordering is required by specific language set forth in the claims below. For example, operations described sequentially may in some cases be rearranged or performed concurrently. Moreover, for the sake of simplicity, the figures may not show the various ways in which the disclosed methods, apparatus, and systems can be used in conjunction with other methods, apparatus, and systems. Additionally, the description sometimes uses terms like “generate”, “determine,” “identify” and “access” to describe the disclosed methods. These terms are high-level abstractions of the actual operations that are performed. The actual operations that correspond to these terms may vary depending on the particular implementation and are readily discernible by one of ordinary skill in the art.

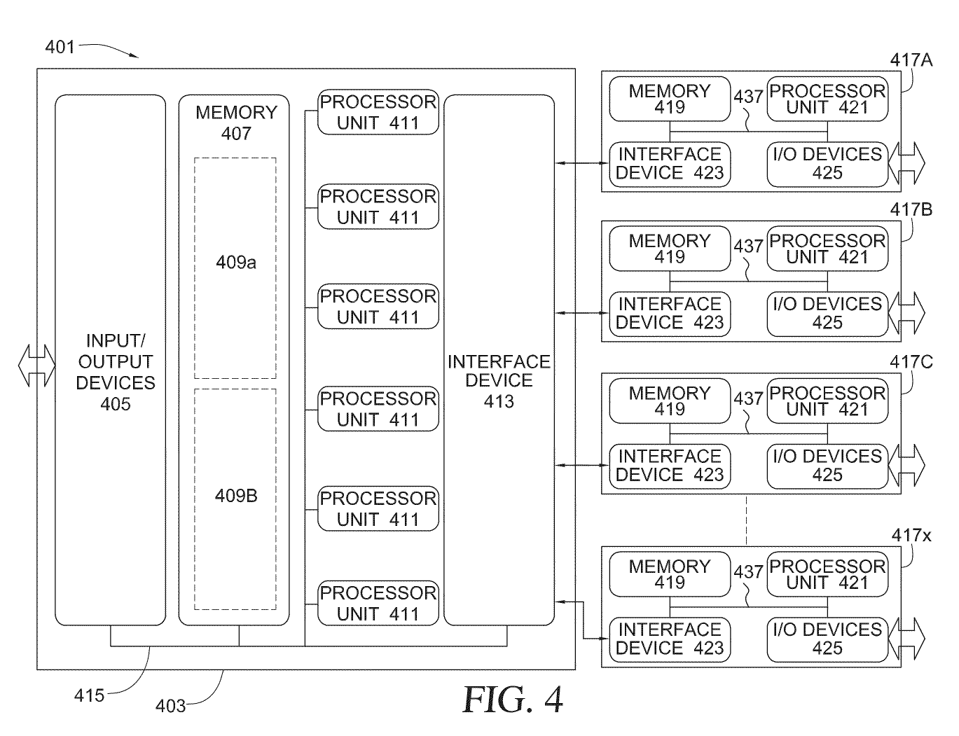

Various embodiments of the invention are implemented using computer executable software instructions executed by one or more programmable computing devices. Because these examples of the invention may be implemented using software instructions, the components and operation of a generic programmable computer system on which various embodiments of the invention may be employed is described. Further, because of the complexity of some electronic design automation processes and the large size of many circuit designs, various electronic design automation tools are configured to operate on a computing system capable of simultaneously running multiple processing threads. The components and operation of a computer network 401 having a host or master computer and one or more remote or slave computers therefore will be described with reference to FIG. 4. This operating environment is only one example of a suitable operating environment, however, and is not intended to suggest any limitation as to the scope of use or functionality of the invention.

In FIG. 4, the computer network 401 includes a master computer 403. In the illustrated example, the master computer 403 is a multi-processor computer that includes a plurality of input and output devices 405 and a memory 407. The input and output devices 405 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 407 may similarly be implemented using any combination of computer readable media that can be accessed by the master computer 403. The computer readable media may include, for example, microcircuit memory devices such as random access memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 403 runs a software application for performing one or more operations according to various examples of the invention. Accordingly, the memory 407 stores software instructions 409A that, when executed, will implement a software application for performing one or more operations. The memory 407 also stores data 409B to be used with the software application. In the illustrated embodiment, the data 409B contains process data that the software application uses to perform the operations, at least some of which may be parallel.

The master computer 403 also includes a plurality of processor units 411 and an interface device 413. The processor units 411 may be any type of processor device that can be programmed to execute the software instructions 409A, but will conventionally be a microprocessor device. For example, one or more of the processor units 411 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 411 may be a custom manufactured processor, such as a microprocessor designed to optimally perform specific types of mathematical operations. The interface device 413, the processor units 411, the memory 407 and the input/output devices 405 are connected together by a bus 415.

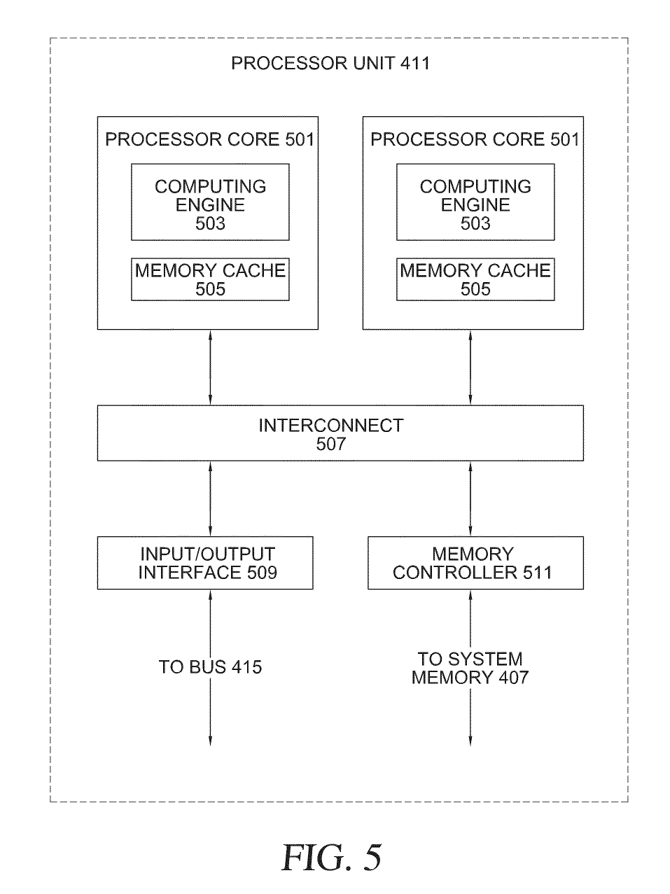

With some implementations of the invention, the master computing device 403 may employ one or more processing units 411 having more than one processor core. Accordingly, FIG. 5 illustrates an example of a multi-core processor unit 411 that may be employed with various embodiments of the invention. As seen in this figure, the processor unit 411 includes a plurality of processor cores 501. Each processor core 501 includes a computing engine 503 and a memory cache 505. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 503 may then use its corresponding memory cache 505 to quickly store and retrieve data and/or instructions for execution.

Each processor core 501 is connected to an interconnect 507. The particular construction of the interconnect 507 may vary depending upon the architecture of the processor unit 501. With some processor cores 501, such as the Cell microprocessor created by Sony Corporation, Toshiba Corporation and IBM Corporation, the interconnect 507 may be implemented as an interconnect bus. With other processor cores 501, however, such as the Opteron™ and Athlon™ dual-core processors available from Advanced Micro Devices of Sunnyvale, Calif., the interconnect 507 may be implemented as a system request interface device. In any case, the processor cores 501 communicate through the interconnect 507 with an input/output interfaces 509 and a memory controller 511. The input/output interface 509 provides a communication interface between the processor unit 511 and the bus 415. Similarly, the memory controller 511 controls the exchange of information between the processor unit 411 and the system memory 407. With some implementations of the invention, the processor units 411 may include additional components, such as a high-level cache memory accessible shared by the processor cores 501.

While FIG. 5 shows one illustration of a processor unit 411 that may be employed by some embodiments of the invention, it should be appreciated that this illustration is representative only, and is not intended to be limiting. For example, some embodiments of the invention may employ a master computer 403 with one or more Cell processors. The Cell processor employs multiple input/output interfaces 509 and multiple memory controllers 511. Also, the Cell processor has nine different processor cores 501 of different types. More particularly, it has six or more synergistic processor elements (SPEs) and a power processor element (PPE). Each synergistic processor element has a vector-type computing engine 503 with 128×128 bit registers, four single-precision floating point computational units, four integer computational units, and a 256 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 411 can be used in lieu of multiple, separate processor units 411. For example, rather than employing six separate processor units 411, an alternate implementation of the invention may employ a single processor unit 411 having six cores, two multi-core processor units 411 each having three cores, a multi-core processor unit 411 with four cores together with two separate single-core processor units 411, or other desired configuration.

Returning now to FIG. 4, the interface device 413 allows the master computer 403 to communicate with the slave computers 417A, 417B, 417C . . . 417x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 413 translates data and control signals from the master computer 403 and each of the slave computers 417 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each slave computer 417 may include a memory 419, a processor unit 421, an interface device 423, and, optionally, one more input/output devices 425 connected together by a system bus 427. As with the master computer 403, the optional input/output devices 425 for the slave computers 417 may include any conventional input or output devices, such as keyboards, pointing devices, microphones, display monitors, speakers, and printers. Similarly, the processor units 421 may be any type of conventional or custom-manufactured programmable processor device. For example, one or more of the processor units 421 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 421 may be custom manufactured processors, such as microprocessors designed to optimally perform specific types of mathematical operations. Still further, one or more of the processor units 421 may have more than one core, as described with reference to FIG. 4 above. For example, with some implementations of the invention, one or more of the processor units 421 may be a Cell processor. The memory 419 then may be implemented using any combination of the computer readable media discussed above. Like the interface device 413, the interface devices 423 allow the slave computers 417 to communicate with the master computer 403 over the communication interface.

In the illustrated example, the master computer 403 is a multi-processor unit computer with multiple processor units 411, while each slave computer 417 has a single processor unit 421. It should be noted, however, that alternate implementations of the invention may employ a master computer having single processor unit 411. Further, one or more of the slave computers 417 may have multiple processor units 421, depending upon their intended use, as previously discussed. Also, while only a single interface device 413 or 423 is illustrated for both the master computer 403 and the slave computers 417, it should be noted that, with alternate embodiments of the invention, either the master computer 403, one or more of the slave computers 417, or some combination of both may use two or more different interface devices 413 or 423 for communicating over multiple communication interfaces.

With various examples of the invention, the master computer 403 may be connected to one or more external data storage devices. These external data storage devices may be implemented using any combination of computer readable media that can be accessed by the master computer 403. The computer readable media may include, for example, microcircuit memory devices such as random access memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the slave computers 417 may alternately or additions be connected to one or more external data storage devices. Typically, these external data storage devices will include data storage devices that also are connected to the master computer 403, but they also may be different from any data storage devices accessible by the master computer 403.

It also should be appreciated that the description of the computer network illustrated in FIG. 4 and FIG. 5 is provided as an example only and is not intended to suggest any limitation as to the scope of use or functionality of alternate embodiments of the invention.

### First Illustrative Implementation of Wire Harness Unfolding

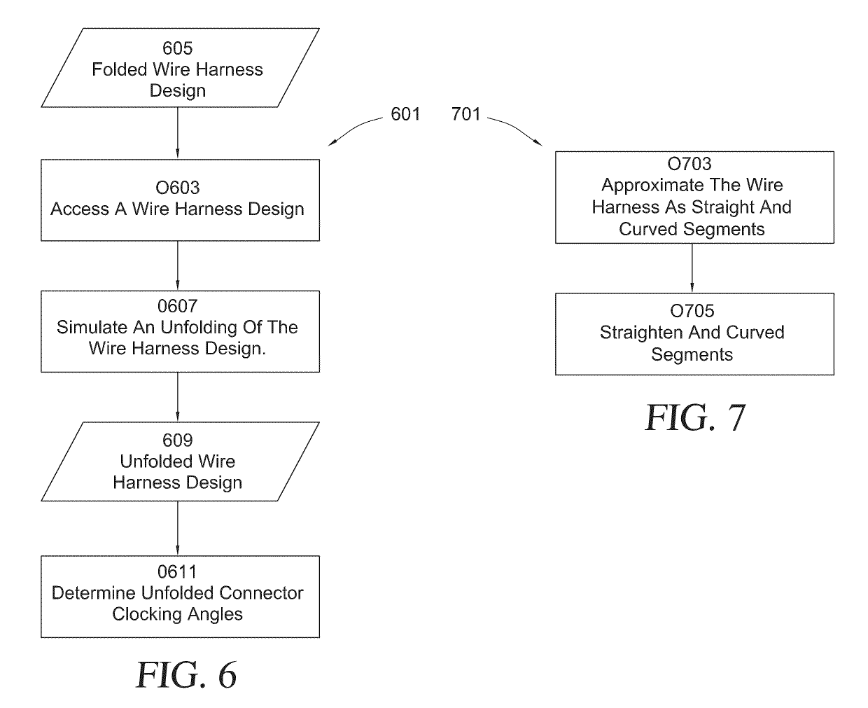

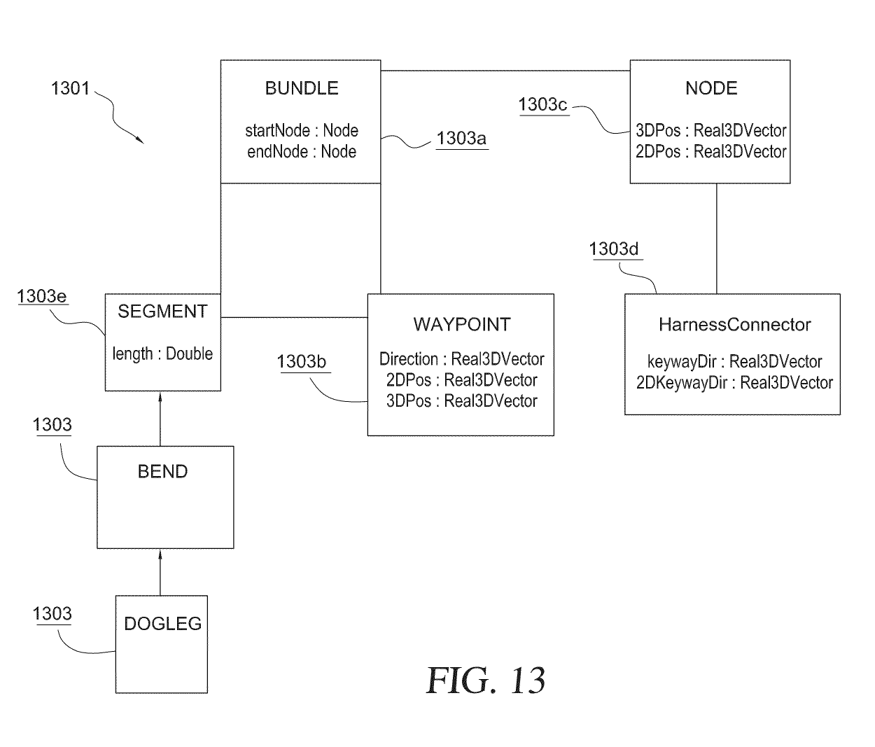

As stated above, various implementations of the invention may be employed to unfold a wire harness design from a three-dimensional representation to a two-dimensional representation. FIG. 6 illustrates a method 601 that may be provided according to various implementations of the invention. The method 601 includes an operation 603 for accessing a folded wire harness design 605. With various implementations of the invention, the folded wire harness design 605 is stored as an xml object model. For example, FIG. 13 illustrates an object model 1301 that may be utilized by various implementations of the present invention to describe a wire harness design.

As can be seen from this figure, the object model 1301 includes fields 1303 that describe various properties of a wire harness branch, which may alternatively be referred to herein as a bundle. Particularly, the object model 1301 includes a node field 1303a that defines a start and end node of the bundle, a waypoint field 1303b that defines waypoints along the bundle, a coordinate field 1303c that defines coordinate locations of the nodes, a clocking field 1303d that defines connector clocking angles for the bundle, and a segment field 1303e that defines segments within the bundle. As illustrated by FIG. 13, an object model may be employed to describe various properties of a wire harness. The various properties mentioned above, such as for example waypoints and segments will be further described below in connection with the various implementations of the invention described herein. Those of skill in the art can appreciate that other object models, besides the object model 1301, may be employed to describe a wire harness. Additionally it should be appreciated that not all object models used to describe a wire harness design will require the specific fields illustrated in FIG. 13.

Returning to FIG. 6, the method 601 further includes an operation 607 for simulating an unfolding of the folded wire harness design 605, resulting in an unfolded wire harness design 609, and an operation 611 for determining the unfolded connector clocking angles corresponding to the folded wire harness design 605. In various implementations of the present invention, the connector clocking angle includes a connector key angle and a connector backshell angle. For example, the connector clocking angle may comprise the angular rotation 113 and the angular rotation 115 illustrated in FIG. 1.

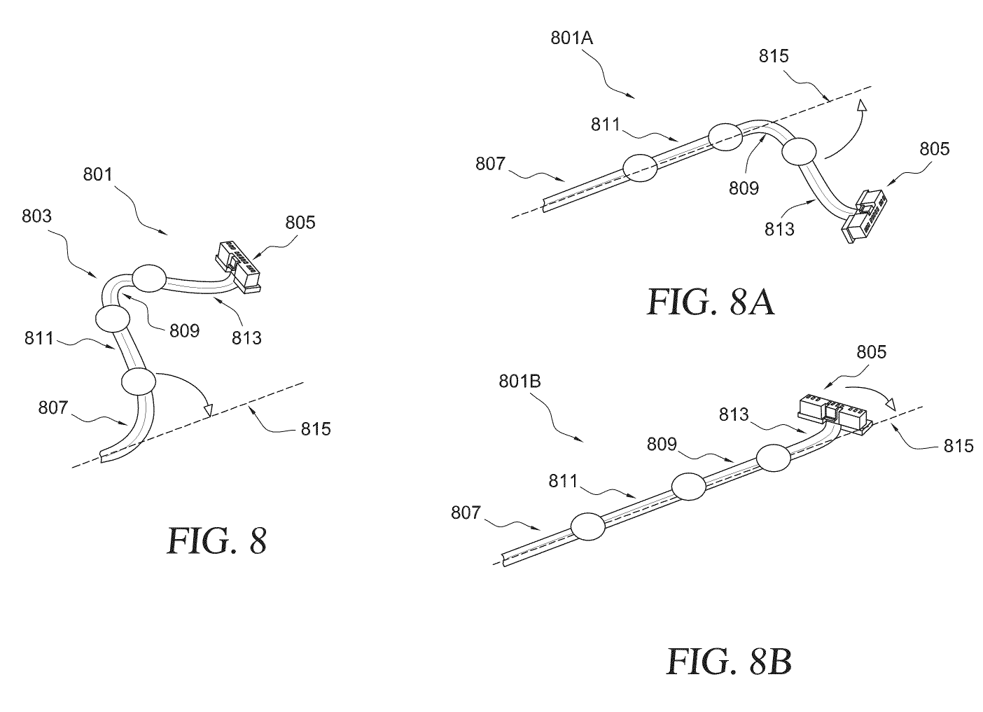

FIG. 7 illustrates a method 701 that may be employed in various implementations of the invention to perform the operation 607 of FIG. 6 for simulating an unfolding of the wire harness design. As can be seen from FIG. 7, the method 701 includes an operation 703 for approximating the wire harness design as straight and curved segments and an operation 705 for straightening the curved segments. In various implementations of the invention, the operation 703 approximates the wire harness as an alternating series of straight and curved segments. For example, FIG. 8 illustrates a wire harness 801 that may be approximated as an alternating series of straight and curved segments according to various implementations of the invention.

As can be seen from this figure, the wire harness 801 has a branch 803 and an electrical connector 805. Additionally, the wire harness 801 is in a folded position. More particularly, the wire harness is not substantially flat along a two-dimensional plane. Furthermore, the electrical connector 805 has a particular positioning in three-dimensional space, which contributes to the connector clocking angle of the electrical connector 805. As stated above, a connector clocking angle is given based upon a particular reference point. In various implementations of the invention, the connector clocking angles are given in Cartesian coordinates. With various implementations of the invention, the connector clocking angles are given in spherical coordinates. The connector clocking angle corresponding to the folded position, as illustrated in FIG. 8, may be referred to herein as the folded connector clocking angle. More particularly, the folded connector clocking angle as used herein refers to the connector clocking angle of an electrical connector when the wire harness the electrical connector is attached to is in a folded position. As can be further seen from this figure, the branch 803 has been approximated as having curved segments 807 and 809 and straight segments 811 and 813.

Returning to FIG. 7, the method 701 includes the operation 705 for straightening the curved segments of the folded wiring harness. In various implementations of the invention, this may be accomplished by selecting an unfolding direction and straightening a curved segment along the unfolding direction. For example, FIG. 8 illustrates an unfolding direction 815. Accordingly, in various implementations of the invention, the curved segment 807 may be straightened along the unfolding direction 815 as the remaining branch segments, i.e. the segments 811, 809, and 813 maintain the same relative position to the straightened branch. FIG. 8A illustrates a wiring harness 801A, which is the wiring harness 801 from FIG. 8 having the curved segment 807 straightened along the unfolding direction 815. As can be seen from FIG. 8A, the wiring harness 801A is in a semi-folded position, as the wiring harness 801A is not substantially flat along a two-dimensional plane. However, notice that as the curved segment 807 was unfolded along the unfolding direction 815, the electrical connector 805 changed positions in three-dimensional space. More particularly, the position of the electrical connector has changed relative to its folded position as shown in FIG. 8. As a result, the corresponding connector clocking angle will also have changed.

In various implementations of the invention, the operation 705 of FIG. 7 may be repeated until all curved segments have been straightened along the unfolding direction. For example, FIG. 8B illustrates a wiring harness 801B, which is the wiring harness 801A of FIG. 1 having the curved segment 809 unfolded along the unfolding direction 815. As can be seen from FIG. 8B, the wiring harness 801B is substantially flat along a two-dimensional plane (i.e. the unfolding direction 815). Accordingly, the wiring harness 801B is in an unfolded position. Additionally, as can be seen, as the curved segment 809 was unfolded along the unfolding direction 815, the electrical connector 805 again changed position relative to the initial position shown in FIG. 8. Accordingly, FIG. 8B shows the unfolded connector clocking angle for the electrical connector 805, while FIG. 8 shows the folded connector clocking angle.

Returning to FIG. 6, the method 601 includes the operation 611 for determining the unfolded connector clocking angles from the unfolded wire harness design. In various implementations of the invention, the operation 611 determines the connector clocking angles based upon the position of the electrical connector in the unfolded wiring harness design. For example, the unfolded connector clocking angle for the electrical connector 805 shown in the folded wire harness 801 of FIG. 8 may be determined based upon the position of the electrical connector 805 in FIG. 8B.

### Segment Straightening

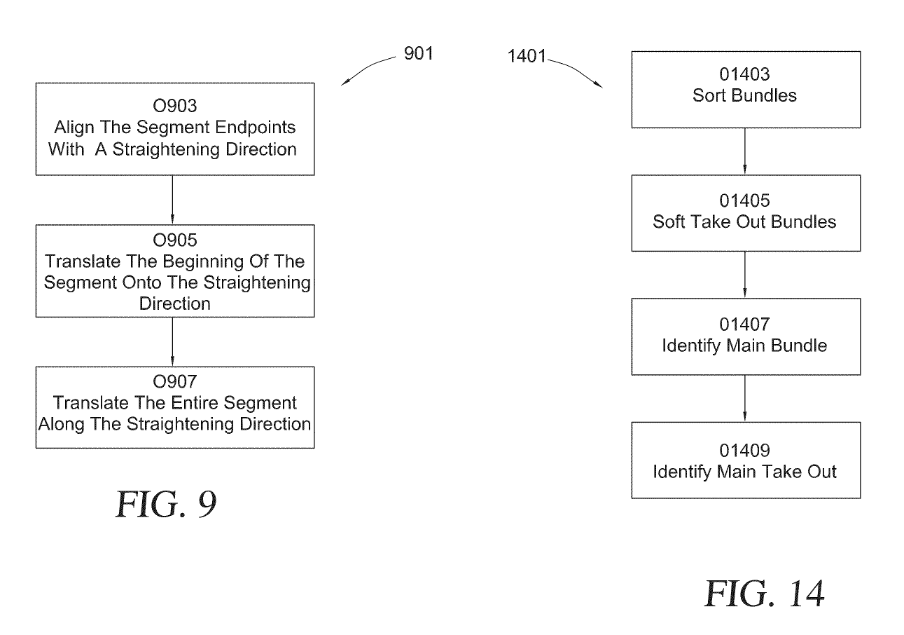

As stated above, various implementations of the invention determine an unfolded connector clocking angle from a simulated unfolding of the wire harness. For example, by application of the method 601 illustrated in FIG. 6 as indicated above. As further stated above, a wire harness may be unfolded by segmenting the wire harness and straightening ones of the segments such that the entire wire harness lies in a two-dimensional plane. FIG. 9 illustrates a method 901 that may be employed to straighten a segment of a wire harness branch. As can be seen from this figure, the method 901 includes an operation 903 for rotating the segment to align with a straightening direction, an operation 905 for translating the beginning of the segment onto the straightening direction, and an operation 907 for translating the entire segment along the straightening direction.

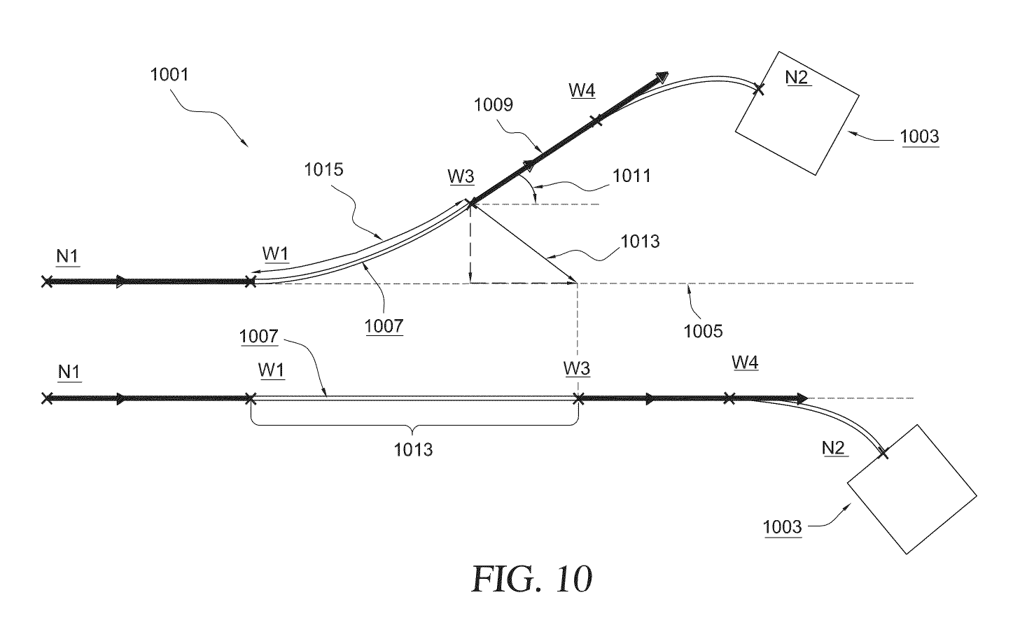

FIG. 10 illustrates a harness branch 1001 having endpoints N1 and N2 and a connector 1003 attached to the endpoint N2, that may have a segment straightened according to the method 901. Furthermore, as can be seen, the harness branch has been segmented as indicated by waypoints W1, W3, and W4. An unfolding direction 1005 is additionally shown. As evident from FIG. 10, the harness branch 1001 is planar. More particularly, the branch already lies is a two-dimensional plane. However, the methods for straightening a segment or a branch onto an unfolding direction described herein and in connection with FIG. 10 are applicable to the more general case where a branch is not planar but instead lies in three-dimensional space.

In various implementations of the invention, the operation 903 of FIG. 9 rotates the tangents of the segment to be unfolded such that the tangents are aligned with the unfolding direction. For example, for a segment 1007 defined by the waypoints W1 and W3 of FIG. 10, the operation 903 may cause a segment 1009 defined by the waypoints W3 and W4 to be rotated such that the segment 1009 is aligned with the unfolding direction 1005, as illustrated by the rotation 1011. The method 901 further includes an operation 905 for translating the segment 1007 start point (i.e. W1) onto the unfolding direction 1005. In various implementations of the invention, the operation 905 orthogonally projects the start point onto the unfolding direction. Additionally, the method 901 includes an operation for translating the entire segment 1007 onto the unfolding direction. With various implementations of the invention, the operation 907 causes the segment 1007 to be brought down to a line along the unfolding direction 1005 wherein the distance between the endpoints W1 and W3 remain unchanged. For example, FIG. 10 shows the translation 1013, which aligns the endpoints of the segment 1007 (i.e. W1 and W3) onto the unfolding direction 1005, such that the length of the segment 1007 (i.e. 1015) remains unchanged. As a result, the segment 1007 is unfolded onto the unfolding direction 1005.

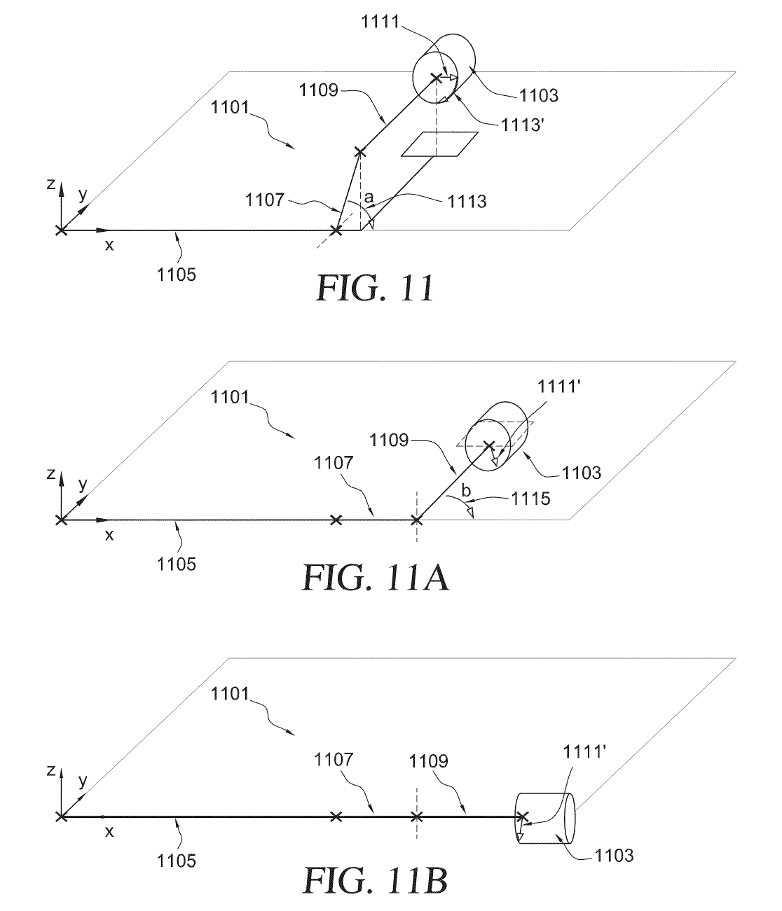

FIG. 11, FIG. 11A and FIG. 11B are illustrative of an additional application of unfolding a wire harness branch. As can be seen from FIG. 11, a wire harness branch 1101 is shown, having a connector 1103. Additionally as can be seen, the wire harness branch 1101 has segments 1105, 1107, and 1109. As a segment is projected into each of the x, y, and z directions, the harness branch 1101 lies in three-dimensional space (i.e. the wire harness 1101 is in the folded position). As further illustrated, the connector 1103 has a folded clocking angle 1111. As can be seen, the folded clocking angle 1111 is nine o'clock when looking into the connector 1103 towards the segment 1109. In various implementations of the invention, the wire harness branch 1101 may be unfolded by rotating the segment 1107 to align with an unfolding direction (i.e. the x axis), as indicated by the rotation 1113. As can be seen, the rotation 1113 will cause the folded clocking angle 1111 to rotate (i.e. 1113′) in a corresponding direction.

FIG. 11A illustrates the wire harness branch 1101 having segments 1105 and 1107 aligned with the unfolding direction. As can be seen from this figure, the shifted connecter clocking angle 1111′ shows the folded connector clocking angle 1111, shifted by the rotation 1113′. The segment 1109 may subsequently be aligned with the unfolding direction by rotating the segment along the direction 1115. However, as can be seen from this figure, the rotation 1115 will not cause a corresponding change in the shifted clocking angle 1111′. FIG. 11B illustrates the wire harness branch 1101 unfolded along the unfolding direction. As can be seen from this figure, the unfolded clocking angle 1111′ (i.e. the shifted clocking angle form FIG. 11A) equals the folded clocking angle minus the rotation 1113′.

Returning to FIG. 6, as stated above, the method 601 may be employed to unfold a wire harness design. For example, FIGS. 8, 10, and 11 illustrate the unfolding of a wire harness design. However, as can be seen from these figures, the wire harness designs represented have a single branch. As described above, a typical wire harness will have multiple branches, such as for example the wire harness branch 201 of FIG. 2 and FIG. 3. The method 601 of FIG. 6 may be generalized to unfold a wire harness design having more than one branch. Additionally, an second method for unfolding a wire harness design is detailed below.

### Second Illustrative Implementation of Wire Harness Unfolding

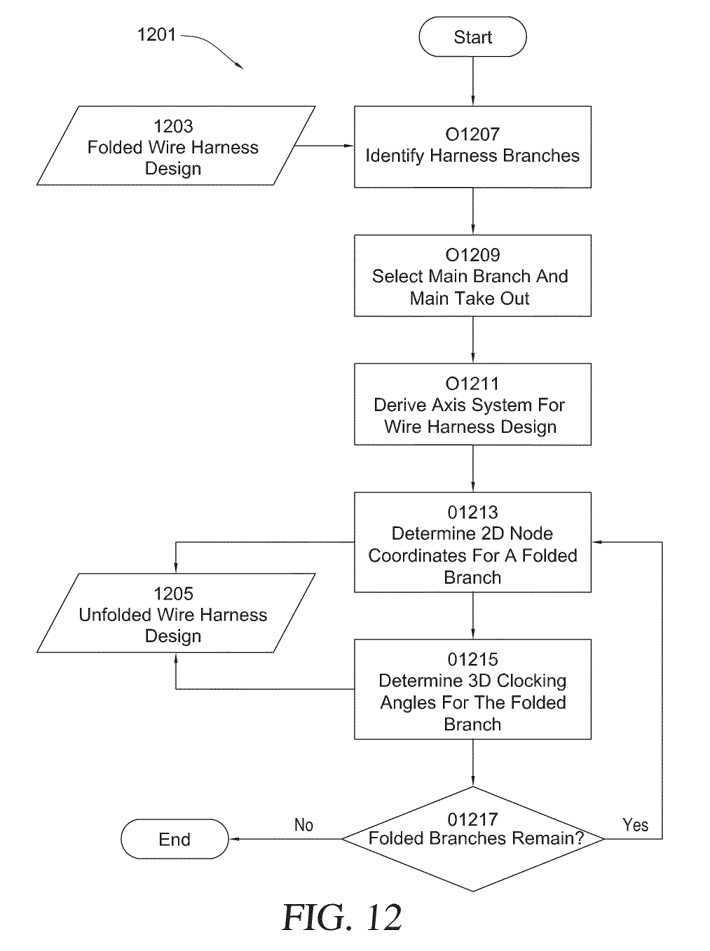

FIG. 12 illustrates a method 1201 that may be implemented by various embodiments of the present invention to unfold a wire harness design. As can be seen from this figure, the method 1201 takes as input a folded wire harness design 1203 and generates a corresponding unfolded wire harness design 1205. The method 1201 includes: an operation 1207 for identifying the harness branches in the folded wire harness design 1203; an operation 1209 for selecting a main branch and main take out branch for the wire harness design 1203; an operation 1211 for deriving an axis system for the wire harness design; an operation 1213 for determining two-dimensional node coordinates for a folded branch of the wire harness design 1203; and operation 1215 for determining folded and unfolded clocking angles for the folded branch of the wire harness design; and an operation 1217 for repeating the operations 1213 and 1215 for additional wire harness branches that have not been unfolded.

In various implementations of the invention, the operation 1207 identifies the branches of the folded wire harness design 1203 by referencing bundles specified by an object model, such as for example the object model 1301 of FIG. 13. In still various implementations of the invention, the operation 1207 may traverse the wire harness design and generate start and end node coordinates for branches within the wire harness design, thereby identifying the branches within the wire harness design 1203.

FIG. 14 illustrates a method 1401 that may be implemented with various embodiments of the invention to perform the operation 1209 for identifying a main branch and main take out branch. As can be seen from FIG. 14, the method 1401 includes an operation 1403 for sorting the bundles. In various implementations of the invention, the operation 1403 sorts the bundles in descending diameter order. The method 1401 further includes an operation 1405 for sorting the take out bundles. With various implementations of the invention, the operation 1405 sorts the take out bundles in descending diameter order. With still various implementations of the invention, the operation 1405 is performed for each bundle. Accordingly, for each bundle, the operation 1405 may sort the connected bundles, such as for example in descending diameter order.

The method 1401 further includes an operation 1407 for identifying a main bundle and an operation 1409 for identifying a main take out. In various implementations of the invention, the operation 1407 identifies as the main bundle, the bundle with the largest diameter while the operation 1409 identifies as the main take out, the bundle with the largest diameter that is connected to the main bundle (i.e. is a take-out from the main bundle). With various implementations of the invention, the bundle selected as the main bundle will not have any take outs, and as a result, the main take out may be null. With still various implementations of the present invention, the main bundle and main take out will be provided to the harness unfolding tool, such as for example by a user. Accordingly, the method 1401 would identify as the main bundle and the main take out, the corresponding bundles provided to the tool.

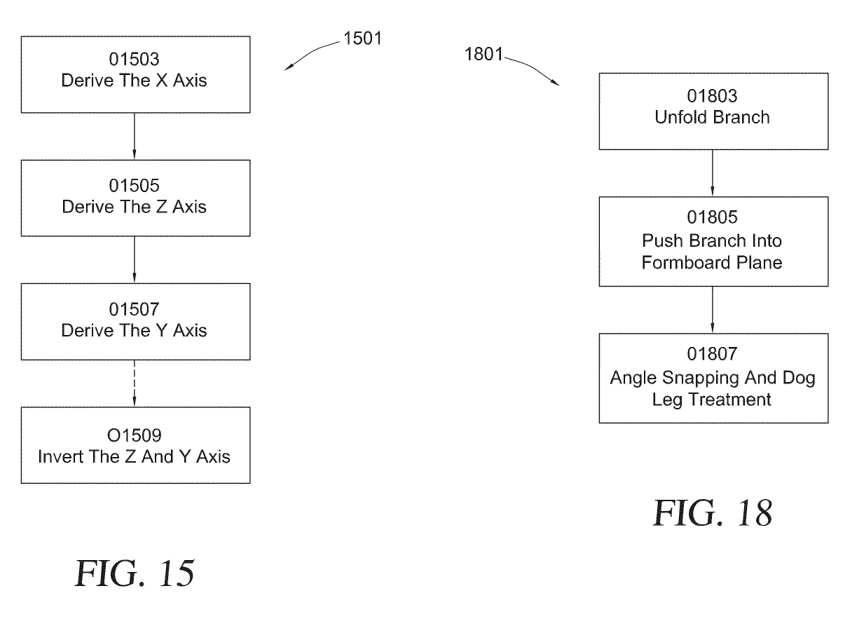

Returning to the method 1201 and FIG. 12, the operation 1211 for deriving an axis system for the harness design is provided. As described herein, a Cartesian coordinate system is utilized to derive the axis system. However, as described above various coordinate systems exist that are suitable for use and may be substituted for the Cartesian coordinate system used herein. FIG. 15 illustrates a method 1501 that may be employed in various implementations of the present invention to perform the operation 1211 of FIG. 12. As can be seen from FIG. 15, the method 1501 includes an operation 1503 for deriving the X axis, an operation 1505 for deriving the Z axis, and an operation 1507 for deriving the Y axis. With some implementations of the invention, the method 1501 may include a further step for inverting the Z and Y axis.

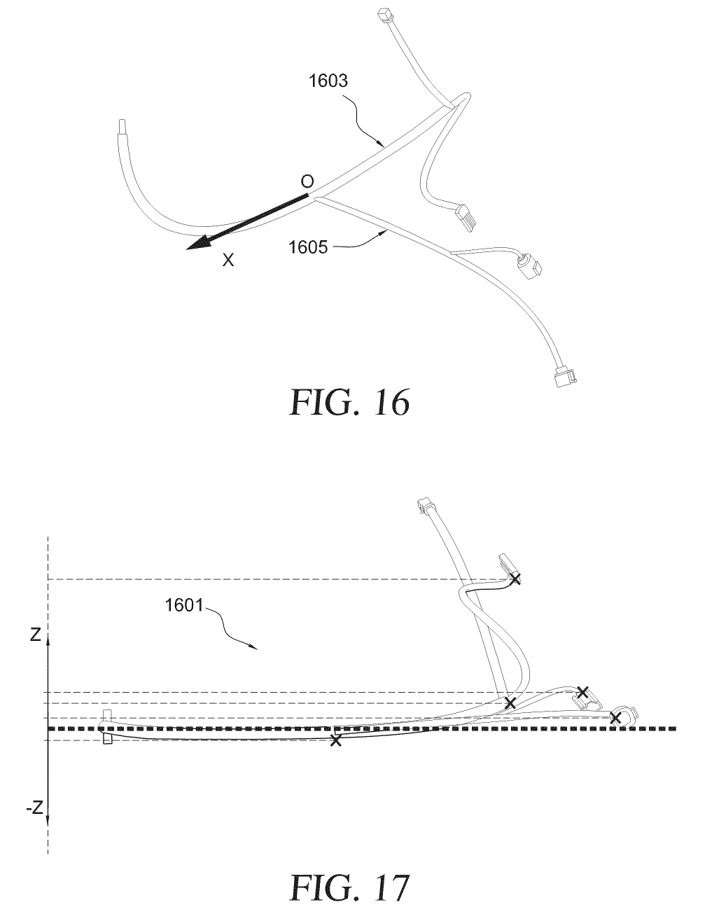

In various implementation of the present invention, the operation 1503 sets the X axis equal to the main bundle. For example, FIG. 16 illustrates a wire harness 1601, having a main branch 1603 and a main take out 1605. As stated, various implementations of the present invention may set the X axis equal to the main bundle 1605, as illustrated in FIG. 16. With various implementations of the present invention, the operation 1505 sets an origin point O as the start node of the main bundle (i.e. see FIG. 16) and derives the Z axis as a vector normal to the main bundle (not shown in FIG. 16). With still various implementations of the invention the operation 1505 derives an origin point O as the intersect of the main bundle and the main take out. For example, the equation O=MB∩MT may be used to derive the origin point. Subsequently, the Z axis may be derived as the wedge product of the main bundle and the main take out. For example, the equation Z=MB [symbol] MT may be used to derive the Z axis. As stated, the method 1601 includes the operation 1607 for deriving the Y axis. In various implementations of the present invention, the Y axis is derived as the wedge product of the Z axis and the X axis. For example, the equation Y=Z [symbol] X may be used to derive the Y axis. As stated, some implementations of the invention include the operation 1509 for inverting the Z and Y axis. With various implementations of the invention, the operation 1509 will invert the Z and Y axis if the sum of the Z coordinates for the bundle is negative. For example, the sum

$${\sum }_{N} n \cdot Z ,$$

where N is the number of nodes in the wire harness (n being a particular node), may be employed to determine if the operation 1509 should invert the Z and Y axis.

As discussed above, wire harnesses are manufactured in a single plane. Often the plane employed to manufacture a wire harness is referred to as a formboard. Accordingly, the method 1501 may be referred to as deriving the formboard plane for the wire harness. It is often desirable during manufacturing to have the majority of the bundles fold up away from the formboard plane. Accordingly, the operation 1509 may be provided as described above. FIG. 17 illustrates this concept. As can be seen from this figure, a side view of the wire harness 1601 of FIG. 16, along with the Z axis is shown. Additionally, the majority of the bundles and take outs extend into the positive Z direction.

### Bundle Pushdown

Returning to FIG. 12, as stated earlier, the method 1201 includes the operation 1213 for determining the 2D node coordinates for a folded branch. FIG. 18, illustrates a method 1801 that may, in various implementations of the present invention, be employed to perform the operation 1213 of FIG. 12. As can be seen from FIG. 18, the method 1801 includes an operation 1803 for straightening the folded branch, forming an unfolded branch, an operation 1805 for pushing the unfolded branch into the formboard plane, and an operation 1807 for performing dog leg treatment.

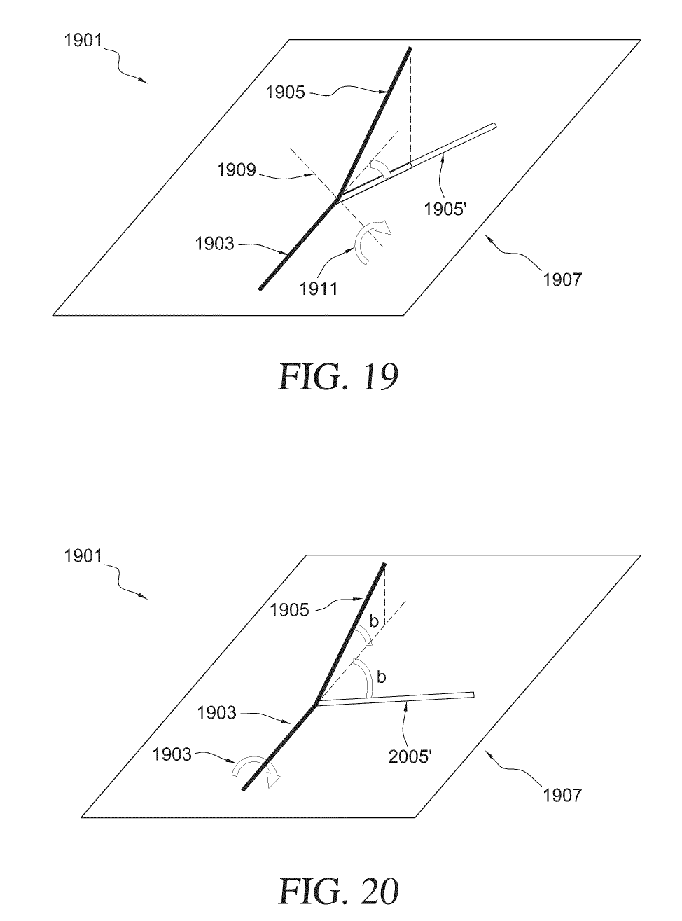

In various implementations of the present invention, the operation 1803 is performed by the method 601 illustrated in FIG. 6. As detailed above, the method 601 may be employed to unfold a harness branch onto an unfolding direction. For example, FIG. 19 illustrates a wire harness design 1901 having branches 1903 and 1905. Additionally, a formboard plane 1907 is represented. As can be seen from this figure, the branches 1903 and 1905 have been straightened. In various implementations of the invention, the branches of the wire harness design 1901 may have been straightened by the method 601. However, as can be seen, the wire harness design 1901 although having straight branches is still projected into three-dimensions. More particularly, the branch 1903 lies in the formboard plane 1907, while the branch 1905 does not lie in the formboard plane 1907. Accordingly, the branch 1905 will need to be translated such that it lies in the formboard plane 1907.

Returning to FIG. 18, as stated, the method 1801 includes the operation 1805 for pushing the unfolded branch into the formboard plane. In various implementations of the invention, the branch is rotated into the formboard plane. For example, returning to FIG. 19, the branch 1905 may be brought into the formboard plane by simulating a rotation of the branch into the formboard plane. More particularly, the branch 1905 may be rotated about an axis 1909 such that the branch 1905 has new position 1905′ in the desired plane (i.e. the formboard plane 1907) as illustrated by the rotation 1911. As can be seen from this figure, the new position 1905′ is the orthogonal projection of the branch 1905 onto the formboard plane.

With various implementations of the invention, a branch may be pushed into a plane by rotating the branch about the main bundle. For example, FIG. 20 illustrates the wire harness design 1901 of FIG. 19, including the branches 1903 and 1905 as well as the formboard plane 1907. As can be seen form FIG. 20, the branch 1905 may be brought into the formboard plane by simulating a rotation 2003 of the branch 1905 about the branch 1903. As can be seen, the new position 2005′ of the branch 1905 lies in the formboard plane 1907. Additionally, as can be seen, the angle b between the branch 1903 and the branch 1905 is preserved between the branch 1903 and the new position 2005′.

### Dogleg Treatment

As discussed above, in some circumstances a branch may include a final bend referred to as a dogleg. In a typical wire harness, the dogleg enables a proper fit between the final portion of a branch and a connector that has an angled backshell. Angled backshells (see for example the backshell 107 of FIG. 1) are often provided to ensure proper fit in a vehicles chassis or body as the branches makes their way to the devices to which they are to be connected. Returning to FIG. 18, the method 1801 includes the operation 1807 for performing dogleg treatment.

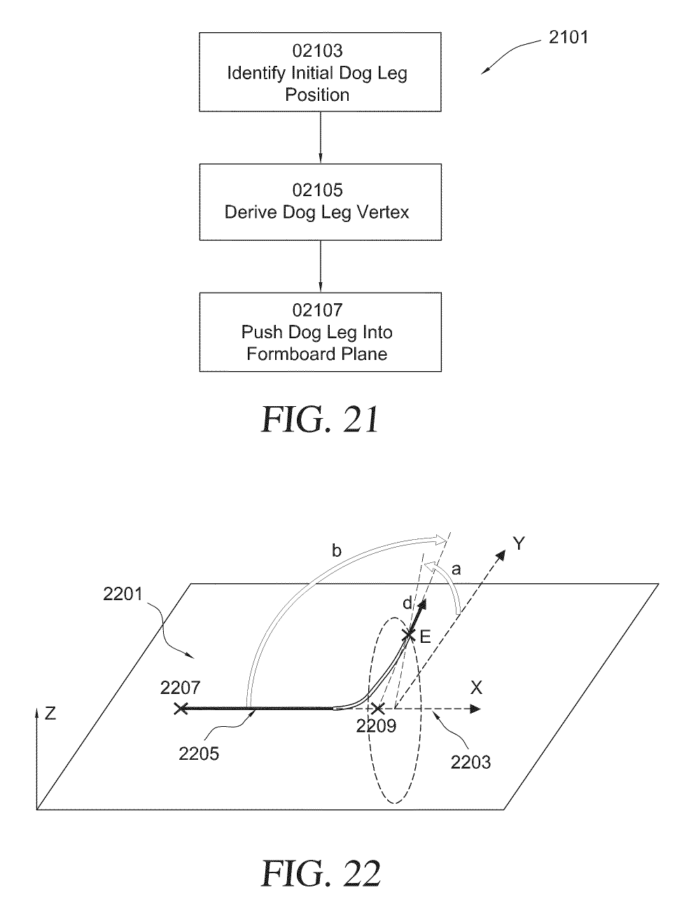

FIG. 21 illustrates a method 2101 that may be employed in various implementations of the present invention to perform dogleg treatment. As can be seen from this figure, the method 2101 includes an operation 2103 for identifying an initial position of the dogleg, an operation 2105 for deriving a vertex for the dogleg and an operation 2107 for pushing the dogleg into the formboard plane. FIG. 22 illustrates a dogleg 2201. Typically, a portion of the dogleg lies along the unfolding direction (assuming that the branch to which the dogleg is attached has been straightened). For example, the dogleg 2201 lies partially along the unfolding direction 2203. Particularly, the section of the dogleg 2205 between the node 2207 and the vertex 2209. The balance of the dogleg is projected above the formboard plane (i.e. the x, y plane).

Returning to FIG. 21, the method 2101 includes the operation 2103 for identifying the initial dogleg position. In various implementations of the present invention, the operation 2103 identifies the dogleg positioning after the branch has been unfolded, such as FIG. 22 shows. The method 2101 further includes the operation 2105 for deriving the dogleg vertex. In various implementations of the invention, the vertex is derived by intersecting the tangents at both ends of the dogleg. For example, the FIG. 22 illustrates the intersection d of the two tangents. Additionally, the initial dogleg position or “elevated” position E is shown.

### Subsequent Unfolding Operations

As detailed above, various implementations of the invention provide for the unfolding of a wire harness design. In various implementations of the invention, after the wire harness is unfolded, the various angles of the branches may be “snapped” to a particular angle. For example, for a wiring harness that includes a main branch and a main takeout branch, the angle between the main branch and the main takeout branch may be set to a specified angle, such as for example 45 degree. Angle snapping may be employed to for example cause distinct branches to show up distinctly in a two-dimensional drawing. It should be noted that any rotation of a bundle in the formboard plane doesn't affect the clocking values at its end node components. As a result, the angle snapping transformation is purely a layout improvement operation.

### CONCLUSION

Various implementations of the invention provide methods and apparatus for determining an unfolded connector clocking angle corresponding to a folded wire harness. More particularly, various implementations of the invention may be employed to manipulate or “unfold” a three-dimensional wire harness representation into a two-dimensional representation such that the two-dimensional connector clocking angle may be determined. In various implementations of the invention, the wire harness is approximated as an alternating series of straight segments and curved segments. Subsequently, the curved segments are straightened or “unfolded” such that the wire harness may be contained within a single geometric plane. As the curved segments are unfolded, the positioning of the wire harness connectors and the connector clocking angles is transformed. As a result, the connector clocking angles for an unfolded wire harness may be determined.

Although certain devices and methods have been described above in terms of the illustrative embodiments, the person of ordinary skill in the art will recognize that other embodiments, examples, substitutions, modification and alterations are possible. It is intended that the following claims cover such other embodiments, examples, substitutions, modifications and alterations within the spirit and scope of the claims.

What is claimed is:

1. A computer implemented method for unfolding a wiring harness design comprising:
accessing a folded wiring harness design, the folded wiring harness design including at least one branch having a connector;
simulating on a computer an unfolding of the folded wiring harness design;
determining an unfolded connector clocking angle for ones of the at least one connector based in part upon the simulated unfolding; and
saving the determined unfolded connector clocking angle to a memory storage location.

2. The computer implemented method recited in claim 1, the method act of simulating on a computer an unfolding of the folded wiring harness design comprising:
approximating the at least one branch of the folded wiring harness design as an alternating series of straight branch segments and curved branch segments; and
straightening the curved branch segments.

3. The computer implemented method recited in claim 2, the method act of straightening the curved branch segments comprising:
selecting a one of the straight branch segments as the first segment;
determining an unfolding direction corresponding to the first segment; and
straightening the curved branch segments based in part upon the unfolding direction.

4. The computer implemented method recited in claim 3, wherein the folded wiring harness design includes a plurality of branches having a connector, the method act of selecting a one of the straight branch segments as the first segment comprising:
designating a one of the plurality of branches as a main branch;
designating a one of the plurality of branches as a main take out branch;
identifying the segment of the main take out branch that intersects the main branch; and
associating the identified segment as the first take out segment.

5. The computer implemented method recited in claim 4, each of the plurality of branches having a corresponding branch diameter, designating a one of the plurality of branches as a main branch comprising:
identifying the one of the plurality of branches having the thickest diameter; and
associating the identified branch as the main branch.

6. The computer implemented method recited in claim 5, designating a one of the plurality of branches as a main take out branch comprising:
identifying the one of the plurality of branches intersecting the main branch having the thickest diameter; and
associating the identified branch as the main take out branch.

7. The computer implemented method recited in claim 6, the method act of determining an unfolding direction corresponding to the first segment comprising:
identifying the straight segment of the main branch intersecting the first take out segment;
associating the identified straight segment as the first main branch segment;
generating a formboard plane from the intersection point between the first take out segment and the first main branch segment, the end of the first take out segment distal from the first main branch segment, and the end of the first main branch segment distal from the first take out segment; and
associating the formboard plane as the unfolding direction.

8. The computer implemented method recited in claim 7, the method act of straightening the curved segments based in part upon the unfolding direction comprising:
straightening the curved segments of the main branch such that the straightened segments and the straight segments of the main branch form a line contained in the unfolding direction;
straightening the curved segments of the main take out branch such that the straightened segments and the straight segments of the main take out branch form a line contained in the unfolding direction; and
for ones of the plurality of branches having un-straightened segments,
straightening the curved segments such that the straightened segments and the straight segments form a line, and
adjusting the straightened branch such that the line formed by the straightened segments and the straight segments is contained in the unfolding direction.

9. The computer implemented method recited in claim 1, further comprising:
generating a formboard drawing based in part upon the mapping; and
saving the formboard drawing to a memory storage location.

10. The computer implemented method recited in claim 1, further comprising:
generating a mapping of the wiring harness design based in part upon the simulated unfolding,
the mapping correlating the wiring harness design between the folded and unfolded positioning, and

11. The computer implemented method recited in claim 1, further comprising determining a folded connector clocking angle for ones of the at least one connector.

12. The computer implemented method recited in claim 11, further comprising determining an unfolded connector clocking angle for ones of the at least one connector.

13. A computer program product for enabling a computer to unfold a wiring harness design comprising:
computer executable instructions for causing a computer to perform a set of predetermined operations; and
at least one computer readable medium bearing the computer executable instructions;
the set of predetermined operations including:
accessing a folded wiring harness design, the folded wiring harness design including at least one branch having a connector;
simulating on a computer an unfolding of the folded wiring harness design;
determining an unfolded connector clocking angle for ones of the at least one connector based in part upon the simulated unfolding; and
saving the determined unfolded connector clocking angle to a memory storage location.

14. The computer program product recited in claim 13, the predetermined operation for simulating on a computer an unfolding of the folded wiring harness design comprising:
approximating the at least one branch of the folded wiring harness design as an alternating series of straight branch segments and curved branch segments; and
straightening the curved branch segments.

15. The computer program product recited in claim 14, the predetermined operation for straightening the curved branch segments comprising:
selecting a one of the straight branch segments as the first segment;
determining an unfolding direction corresponding to the first segment; and
straightening the curved branch segments based in part upon the unfolding direction.

16. The computer program product recited in claim 15, wherein the folded wiring harness design includes a plurality of branches having a connector, the predetermined operation for selecting a one of the straight branch segments as the first segment comprising:
designating a one of the plurality of branches as a main branch;
designating a one of the plurality of branches as a main take out branch;
identifying the segment of the main take out branch that intersects the main branch; and
associating the identified segment as the first take out segment.

17. The computer program product recited in claim 16, wherein each of the plurality of branches having a corresponding branch diameter, the predetermined operation for designating a one of the plurality of branches as a main branch comprising:
identifying the one of the plurality of branches having the thickest diameter; and
associating the identified branch as the main branch.

18. The computer program product recited in claim 17, the predetermined operation for designating a one of the plurality of branches as a main take out branch comprising:
identifying the one of the plurality of branches intersecting the main branch having the thickest diameter; and
associating the identified branch as the main take out branch.

19. The computer program product recited in claim 18, the predetermined operation for determining an unfolding direction corresponding to the first segment comprising:
identifying the straight segment of the main branch intersecting the first take out segment;
associating the identified straight segment as the first main branch segment;
generating a formboard plane from the intersection point between the first take out segment and the first main branch segment, the end of the first take out segment distal from the first main branch segment, and the end of the first main branch segment distal from the first take out segment; and
associating the formboard plane as the unfolding direction.

20. The computer program product recited in claim 19, the predetermined operation for straightening the curved segments based in part upon the unfolding direction comprising:
straightening the curved segments of the main branch such that the straightened segments and the straight segments of the main branch form a line contained in the unfolding direction;
straightening the curved segments of the main take out branch such that the straightened segments and the straight segments of the main take out branch form a line contained in the unfolding direction; and
for ones of the plurality of branches having un-straightened segments,
straightening the curved segments such that the straightened segments and the straight segments form a line, and
adjusting the straightened branch such that the line formed by the straightened segments and the straight segments is contained in the unfolding direction.

21. The computer program product recited in claim 13, the set of predetermined operation further including:
generating a formboard drawing based in part upon the mapping; and
saving the formboard drawing to a memory storage location.

22. The computer program product recited in claim 13, the set of predetermined operations further including:
generating a mapping of the wiring harness design based in part upon the simulated unfolding,
the mapping correlating the wiring harness design between the folded and unfolded positioning, and

23. The computer program product recited in claim 13, the set of predetermined operations further including determining a folded connector clocking angle for ones of the at least one connector.

24. The computer program product recited in claim 23, the set of predetermined operations further including determining an unfolded connector clocking angle for ones of the at least one connector.

25. A computer system for unfolding a wiring harness design comprising:
a processor;
a memory including a software instructions that cause a computer to:
access a folded wiring harness design, the folded wiring harness design including at least one branch having a connector;
simulate on the computer an unfolding of the folded wiring harness design;
determine an unfolded connector clocking angle for ones of the at least one connector based in part upon the simulated unfolding; and
save the determined unfolded connector clocking angle to the memory.
